(19) United States
(12) Patent Application Publication
(10) Pub. No.: US 2006/0072052 A1
(43) Pub. Date: Apr. 6, 2006

(54) Display device

(75) Inventors: Jae-Kwang Kim, Seoul (KR); Jeung-Soo Kim, Seoul (KR); Jong-Nam Lee, Gyeonggi-do (KR); Sang-Hee Lee, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/243,706

(22) Filed: Oct. 4, 2005

(30) Foreign Application Priority Data
Oct. 5, 2004 (KR) 10-2004-0078980
Oct. 7, 2004 (KR) 10-2004-0079868
Oct. 8, 2004 (KR) 10-2004-0080456
Mar. 8, 2005 (KR) 10-2005-0019043

(51) Int. Cl. G02F 1/1333

(52) U.S. Cl. 349/60

(57) ABSTRACT

Disclosed is a display device preventing the quality of display from being deteriorated and preventing malfunctions caused by foreign particles. The display device of the present invention includes two or more panel units and a fixing member exposing at least one panel among the panel units to the outside. The circumference of an opening of the fixing member is sealed.

### CROSS-REFERENCE TO RELATED APPLICATIONS

The present application claims priority to Korean patent application Nos. 2004-0078980, 2004-0079868, 2004-0080456, and 2005-0019043 filed in the Korean Intellectual Property Office on Oct. 5, 2004, Oct. 7, 2004, Oct. 8, 2004, and Mar. 8, 2005, respectively, the contents of which are herein incorporated by reference in their entireties.

### BACKGROUND

(a) Field of the Invention

The present invention relates to a display device, and more particularly to a display device capable of preventing deterioration in the quality of display and malfunctions caused by foreign particles.

(b) Description of Related Art

Recently, with the rapid development of semiconductor technology, the demand for a small-sized and light-weight flat panel display having improved performance has increased dramatically.

Among the flat panel displays, a liquid crystal display (hereinafter referred to as an “LCD”) has merits of small size, light weight, and lower power consumption. Therefore, much attention has been paid to the LCD as an alternative to the existing cathode ray tube (CRT). Recently, LCDs are widely used for almost all information processing apparatuses requiring display devices.

In a typical LCD, a specific molecular alignment is changed into another molecular alignment by applying a voltage thereto, and then a change of optical characteristics of a liquid crystal cell, such as birefringence, optical rotary power, dichroism, optical scattering, etc., are converted into a visual change. That is, the typical LCD is a light-receiving type of display device which displays information using optical modulation by the liquid crystal cells.

Meanwhile, an organic light emitting display (referred to as an “OLED” hereinafter) has been recently noted as one of the next generation display devices. The OLED displays images using a self-emitting phenomenon by combining electrons injected from a negative electrode and pores injected from a positive electrode in an organic compound. The OLED is an active element which emits light by itself. The efficiency of emitting light is high, thereby minimizing the loss of power and providing the OLED with the capability of operating at under 15V. As a result, the OLED is suitable for a small display device with low manufacturing costs.

Therefore, the LCD device or the OLED are adapted to most small display devices used in cellular phones and the like. Many cellular phones have a clamshell type design for the consumer's convenience. Some clamshell type cellular phones include dual displays in which a first display panel unit is installed on the front side of the top half of the phone to enable viewing when the phone is closed, and a second display panel is provided on the back side of the top half of the phone to be viewed when the phone is open.

In the display device included in cellular phones, the combining members are not additionally used for combining elements in order to minimize an occupying space thereof. Therefore, the elements are combined with each other by using combining portions formed therein.

In display devices having the above structure, foreign particles can easily infiltrate the inner side of the display device. Accordingly, when an image is displayed on the LCD panel, the foreign particles are visible as a plurality of points, thereby deteriorating the quality of the display. In addition, the foreign particles infiltrate the inner side of the elements, thereby causing malfunction of the display device due to the foreign particles.

### SUMMARY

In accordance with the present invention, a display device that prevents the quality of display from being deteriorated and prevents malfunctions is provided.

In order to solve the above problems, a display device in accordance with the present invention includes two or more panel units and a fixing member exposing at least one panel among the panel units to the outside. The circumference of an opening of the fixing member is sealed.

Preferably, the display device according to the present invention further includes a light absorbing member positioned between panel units, in order to absorb a portion of light.

The light absorbing member may be attached to a side of the fixing member facing one of the panel units.

The panel units may include a first panel unit and a second panel unit facing the first panel unit. The size of the first panel unit may be larger than that of the second panel unit.

Preferably, the second panel unit is exposed through the opening of the fixing member, and the light absorbing member is attached on the side of the fixing member facing the second panel unit.

The second panel unit and the light absorbing member preferably correspond to the whole surface of the first panel unit.

Preferably, the brightness of the front side of the first panel unit is substantially uniform.

Preferably, the color of the light absorbing member is substantially black.

A sealing member is preferably attached around a circumference of the opening of the fixing member to form a seal between the fixing member and at least one of the panel units.

The fixing member preferably includes a supporting portion formed by cutting and bending a portion of the fixing member adjacent to the sides of the panel unit.

An opening is preferably formed by bending the supporting portion, and tape is attached on the opening to seal it.

Each panel unit may include a first panel and a second panel facing the first panel, and the supporting portion is only adjacent to the side of the second panel.

Preferably, a non-conductive member is attached between the supporting portion and the side of the second panel.

The upper edge of the supporting portion is preferably placed lower than the face of the second panel facing the first panel.

Preferably, a height difference between the upper edge of the supporting portion and the face of the second panel is greater than 0.0 mm and less than or equal to 0.2 mm.

It is preferable that the height of the supporting portion is less than that of the second panel.

Preferably, the display device according to the present invention further includes a supporting member installed around the opening of the fixing member for fixing the panel unit.

The fixing member preferably includes a supporting portion formed in the edges of the opening of the fixing member, and the combining portions formed in the sides of the supporting member are combined with the supporting portion of the fixing member.

Tape is preferably positioned around the opening of the fixing member to form a seal between the fixing member and at least one panel unit.

Preferably, the display device according to the present invention further includes a frame member for containing at least one panel unit. The frame member preferably comprises an opening and a supporting portion protruding around the opening, the supporting portion penetrating the opening of the fixing member.

The supporting portion of the frame member preferably fixes the panel unit by surrounding the panel unit.

Preferably, the fixing member further includes a supporting portion bent around the opening of the fixing member, wherein the supporting portion of the fixing member surrounds the supporting portion of the frame member.

Tape is preferably positioned around the opening of the fixing member to form a seal between the fixing member and one of the panel units.

Preferably, the display device according to the present invention further includes a flexible printed circuit film (hereinafter referred to as an “FPC”) connected to the panel unit, and the bottom surface of the fixing member is spaced apart from the FPC.

Preferably, the display device according to the present invention further includes a non-conductive member positioned between the FPC and the fixing member.

The non-conductive member may comprise a resin film.

The non-conductive member may be attached to the fixing member.

The two or more panel units may include a first panel unit and a second panel unit, and the FPC connects to the first panel unit and the second panel unit.

Preferably, the display device according to the present invention further includes a light source supplying light to the panel unit.

The light source may be a light emitting diode (hereinafter referred to as an “LED”).

At least one panel unit among the panel units may be an LCD panel.

The display device according to the present invention may be used in a cellular phone.

### BRIEF DESCRIPTION OF THE DRAWINGS

The above and other features and advantages of the present invention will become more apparent by describing in detail exemplary embodiments thereof with reference to the attached drawings, in which:

FIG. 1 is an exploded perspective view of a display device according to a first embodiment of the present invention;

FIG. 2 is an assembled view of the display device of FIG. 1;

FIG. 3 is a cross sectional view of line III-III of FIG. 2;

FIG. 4 is a rear perspective view of a display device according to a second embodiment of the present invention;

FIG. 5 is a partial exploded perspective view of a display device according to a third embodiment of the present invention;

FIG. 6 is a rear perspective view of a part of the display device of FIG. 5;

FIG. 7 is a partial exploded perspective view of a display device according to a fourth embodiment of the present invention;

FIG. 8 is a rear perspective view of a part of the display device of FIG. 7; and

FIG. 9A and FIG. 9B are plan views of a first panel unit according to an experimental example of the present invention and a comparative example of the prior art, respectively.

### DETAILED DESCRIPTION

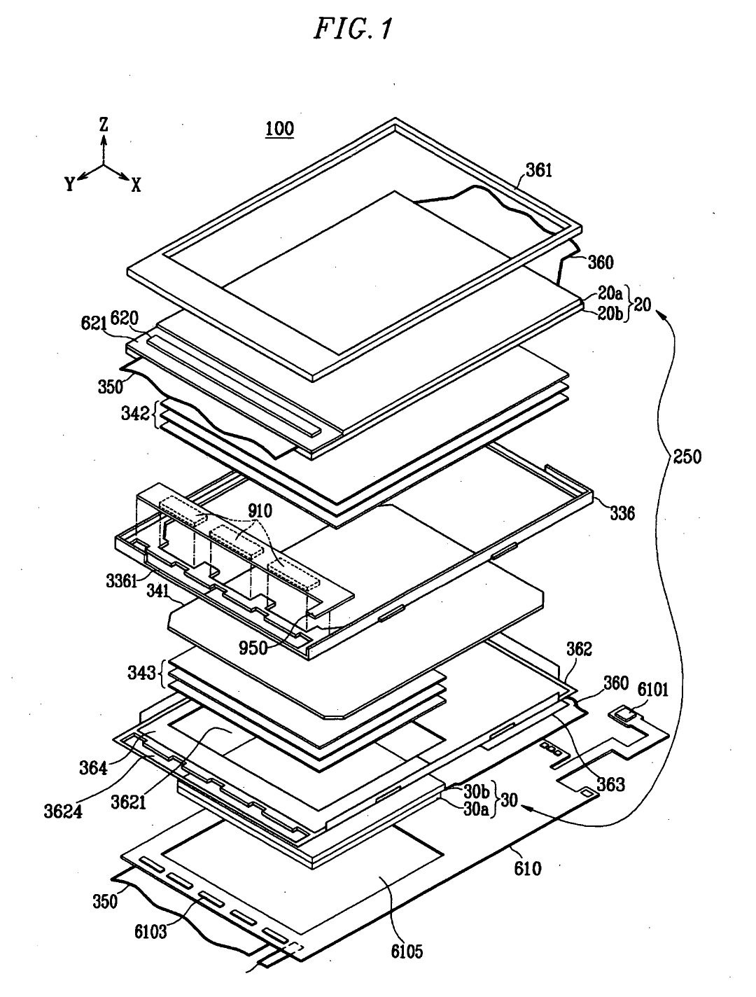

Hereinafter, embodiments of the present invention will be described with reference to FIGS. 1 to 8. Such embodiments of the present invention are to illustrate the present invention, and the scope of the present invention is not limited thereto.

FIG. 1 shows a display device 100 according to the first embodiment of the present invention. The display device 100 includes a first panel unit 20 and a second panel unit 30. Although a dual display device in which the first panel unit 20 and the second panel unit 30 face each other is shown in FIG. 1, this is merely to exemplify the structure of the display device according to the present invention and the present invention is not limited thereto. Therefore, the display device can be manufactured in other forms.

In addition, although the panel units 20 and 30 are shown as LCD panels, this is merely to illustrate the present invention and the present invention is not limited thereto. Therefore, an OLED panel can be used instead of the LCD panel. At least one panel unit among two or more panel units can be used as the LCD panel.

If the LCD panels are used as panel units 20 and 30, a light source 910 is used to supply light to the panel units 20 and 30. A plurality of fixing members 361, 336, and 362 are installed in order to couple the panel units 20 and 30 and the light source 910. The fixing members 361 and 362 may comprise stainless steel and the fixing member 336 may comprise a resin.

A panel unit assembly 250 includes the first panel unit 20, the second panel unit 30, FPCs 350 and 360, an integrated circuit (IC) chip 620, and a flexible printed circuit board (hereinafter referred to as an “FPCB”) 610. Although two adjacent panel units are shown in FIG. 1, this is merely to illustrate the present invention and the present invention is not limited thereto. Therefore, the display device 100 can include more than two panel units.

The display device 100 can be used in a cellular phone. In order to conveniently use the cellular phone, the first panel unit 20 is larger than the second panel unit 30 adjacent to the first panel unit 20. In the case of installing the display device 100 in a cellular phone of a clamshell type, the first panel unit 20 is installed to display an image on the inner side of a first section of the cellular phone, while the second panel unit 30 is installed to display an image on the outer side of the first section of the cellular phone. Therefore, it is possible to display a small amount of information, such as the current time, using the small second panel unit 30 when the cellular phone is closed. In addition, it is possible to display a large amount of information through the large first panel unit 20 when a phone call is necessary by opening the cellular phone.

The internal structure of the first panel unit 20, which is an LCD panel, will be explained in detail below. Since the internal structure of the second panel unit 30 is substantially the same as that of the first panel unit 20, the detailed explanation thereof will be omitted.

The first panel unit 20 includes a TFT (thin film transistor) panel 20b and a color filter panel 20a. The TFT panel 20b comprises a transparent glass panel on which thin film transistors are formed in a matrix arrangement. Data lines are connected to source terminals and gate lines are connected to gate terminals therein. A pixel electrode comprising transparent indium tin oxide (ITO) as a conductive material is formed on the drain terminal.

Electrical signals from the FPCB 610 are input to data lines and gate lines of the first panel unit 20, and are, in turn, input to source terminals and gate terminals of the TFTs. Each TFT is turned on or turned off by inputting the electrical signals, whereby electrical signals required for expressing light from pixels are output to a drain terminal.

The color filter panel 20a is arranged on the TFT panel 20b. The color filter panel 20a comprises a panel on which red, green, and blue (hereinafter referred to as “RGB”) pixels are formed by a thin film process. The RGB pixel reveals a predetermined color when light passes therethrough. A common electrode comprising ITO is coated on a surface of the color filter panel 20a facing the TFT panel 20b. If power is applied to the gate terminals and the source terminals of the TFT, causing the thin film transistor is turned on, an electric field is formed between a pixel electrode and a common electrode of the color filter panel 20a. An array angle of liquid crystals injected between the TFT panel 20b and the color filter panel 20a is changed by the electric field. Light transmittance is controlled by the changed array angle, whereby color from a desired pixel is obtained. A polarizer is provided on the external surfaces of the TFT panel 20b and the color filter panel 20a, respectively.

An integrated circuit (IC) chip 620 applies driving signals and timing signals to gate lines and data lines of the TFT in order to control an array angle of liquid crystals of the first panel unit 20 and the timing of which liquid crystals are arranged. The IC chip 620 attached to the TFT panel 20b is protected by a protection film 621. The IC chip 620 generates a plurality of timing signals for controlling data driving signals and gate driving signals and applies data driving signals and gate driving signals to the gate lines and data lines, respectively.

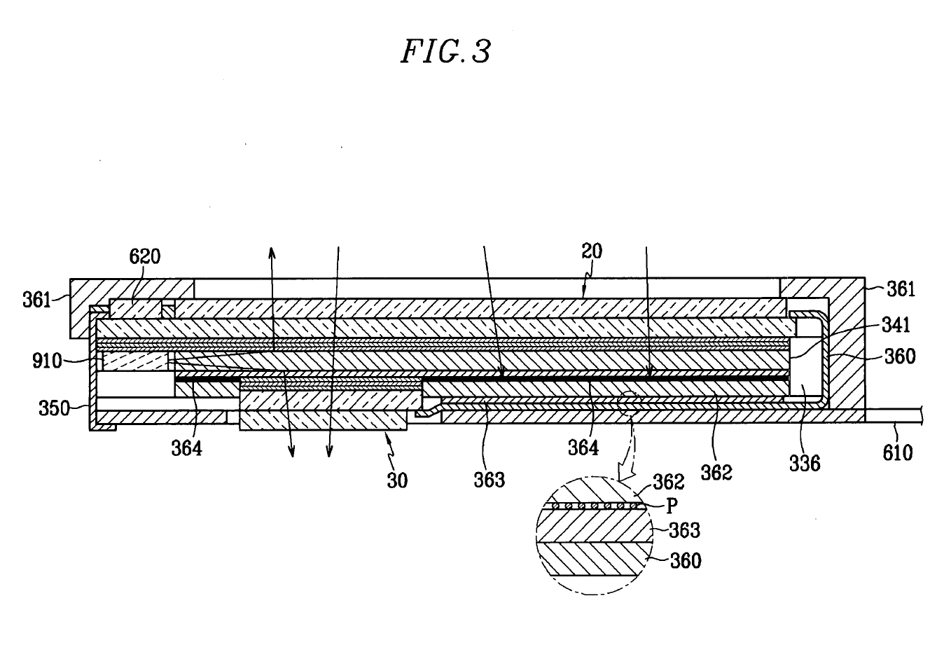

The first panel unit 20 is connected to the second panel unit 30 through the FPC 360. The FPC 360 is shown in FIG. 1 in multiple sections for clarity. However, in normal operation, the multiple sections of the FPC 360 shown in FIG. 1 comprise a single structure, as can be seen in FIG. 3. Since the first panel unit 20 and the second panel unit 30 are connected to each other, the driving signals derived from the IC chip 620 can be transmitted to the second panel unit 30 through the first panel unit 20. Therefore, the IC chip 620 is capable of controlling both the first panel unit 20 and the second panel unit 30.

A plurality of resistors 6103 are mounted on the FPCB 610. The plurality of resistors 6103 are received in openings 3361 and 3624 of the fixing members 336 and 362, respectively.

A cellular phone connector 6101 is mounted on the end portion of the FPCB 610. The FPC 360 receives a signal in accordance with the opening and closing of two halves of the cellular phone through the cellular phone connector 6101. The first panel unit 20 and the FPCB 610 are connected to each other by the FPC 350. The FPC 350 is shown in FIG. 1 in multiple section for clarity. However, in normal operation, the multiple sections of the FPC 350 shown in FIG. 1 comprise a single structure, as can be seen in FIG. 3.

A light source 910 is installed between the first panel unit 20 and the second panel unit 30. The light source 910 supplies uniform light to the panel units 20 and 30. The light source 910 is fixed by the fixing members 336 and 362. A plurality of optical sheets 342 and 343 and a light guiding plate (hereinafter referred to as an “LGP”) 341 improve the brightness and uniformity of the light and supply the light to the panel units 20 and 30.

The light emitted from the light source 910 is guided through the LGP 341. A portion of light guided by the LGP 341 is directed to the first panel unit 20, and the other portion of light passes through the LGP 341 and is directed to the second panel unit 30. To accomplish this, the LGP 341 comprises a material capable of transmitting light. The brightness of light is improved while going through the optical sheets 342 and 343, and the light is supplied to the first panel unit 20 and the second panel unit 30, respectively.

In the embodiment shown in FIG. 1, the light source comprises LEDs mounted on an FPCB 950. However, this is merely to illustrate the present invention and other types of light sources may be used. For example, a linear light source provided with LEDs can be used. The FPCB 950 is electrically connected to a terminal 370. Therefore, the light source 910 is driven by signals for controlling the light source from the FPCB 610.

The fixing member 362 has an opening, 3621. The second panel unit 30 is exposed through the opening 3621 of the fixing member 362 to the outside. The FPCB 950 and the first panel unit 20 are fixed on the fixing member 336, and the fixing member 362 fixing the second panel unit 30 is combined with the fixing member 336. The first panel unit 20 is fixed to the fixing member 336 by covering the first panel unit 20 with the fixing member 361.

The FPCB 610 has an opening 6105. The second panel unit 30 can be exposed through the opening 6105 to the outside. The lower portion of the fixing member 362 is covered with the FPCB 610. In addition, the fixing member 362 and the FPC 360 are separated from each other in order to prevent the fixing member 362 from short circuiting with the FPC 360 by contacting each other. For example, as shown in FIG. 1, a non-conductive member 363 can be inserted between the fixing member 362 and the FPC 360.

A light absorbing member 364 can be attached on the inner side of the fixing member 362. A circumference of the opening 3621 of the fixing member 362 is sealed by attaching the light absorbing member 364 on the circumference thereof. The light absorbing member seals the opening 3621 to prevent foreign particles from infiltrating the display device 100 through the opening 3621. As a result, malfunctions of the display device 100 or deterioration of the display quality caused by foreign particles can be avoided.

The light absorbing member 364 is installed between the first panel unit 20 and the second panel unit 30. The light absorbing member 364 is attached on the inner side of the fixing member 362 around the second panel unit 30. Therefore, a portion of light entering through the first panel unit 20 is not reflected and is absorbed by the light absorbing member 364. Therefore, the brightness of the front side of the first panel unit 20 is substantially uniform.

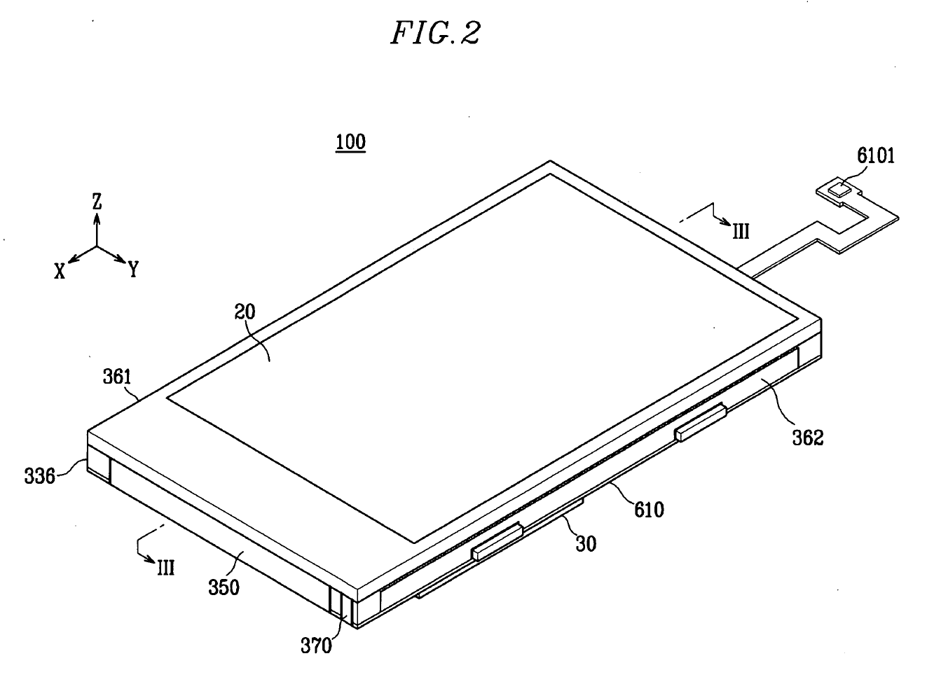

FIG. 2 is a perspective view of the assembled elements of the display device 100 of FIG. 1. The light entering from the outside through the first panel unit 20 is not reflected and is absorbed by the light absorbing member 364 (shown in FIG. 1). Therefore, the brightness of the front side of the first panel unit 20 is substantially uniform. As a result, when images are displayed on the first panel unit 20, dark boundaries caused by the second panel unit 30 are not shown. This will be explained in more detail below with reference to FIG. 3.

FIG. 3 shows a sectional structure of the display device 100 cut along the line III-III of FIG. 2. The light absorbing member 364 is located to correspond to the second panel unit 30 and absorb light therearound. Thus, the uniformity of the brightness of the light can be improved. The light absorbing member 364 may comprise a black resin or a blackish resin, making the light absorbing member 364 suitable for absorbing light.

As indicated by arrows in FIG. 3, a portion of the light entering the outer face of the first panel unit 20 passes though the second panel unit 30. The rest of the light entering the first panel unit 20 is absorbed by the light absorbing member 364, and is not reflected back to the first panel unit 20. Therefore, there is no light reflected to the inner face of the first panel unit 20. As a result, it is possible to display images on the first panel unit 20 without showing the boundaries of the second panel unit 30.

When the display device 100 of FIG. 3 is assembled, significant forces are applied to the display device 100 from the lower direction. The force is directly applied to the FPCB 610, which causes the FPCB 610 to press against the FPC 360. As a result, the fixing member 362 is brought closer to the FPC 360. If the fixing member 362 is made of a metal, a short circuit can occur by contact between the fixing member 362 and the FPC 360.

In the present invention, a non-conductive member 363 is positioned between the FPC 360 and the fixing member 362. The non-conductive member 363 may comprise a resin. The non-conductive member 363 is attached on the fixing member 362 and is firmly fixed. The non-conductive member 363 separates the bottom surface of the fixing member 362 from the FPC 360, thereby preventing a short circuit therebetween.

The surface of the metal fixing member 362 is rigid. Therefore, the wiring of the FPC 360 can be damaged if the bottom surface of the fixing member 362 contacts the FPC 360. However, the non-conductive member 363 is located between the fixing member 362 and the FPC 360, thereby lessening the impact. Therefore, it is possible to prevent the FPC 360 from being damaged.

In particular, as shown in the enlarged circle of FIG. 3, conductive foreign particles P can exist in the lower portion of the fixing member 362. In this case, since the non-conductive member 363 is located between the fixing member 362 and the FPC 360, the non-conductive member 363 prevents the conductive foreign particles P from contacting the FPC 360. Therefore, despite the presence of conductive foreign particles P, a short circuit between the fixing member 362 and the FPC 360 will not occur. As a result, malfunctions of the display device 100 caused by short circuiting can be avoided.

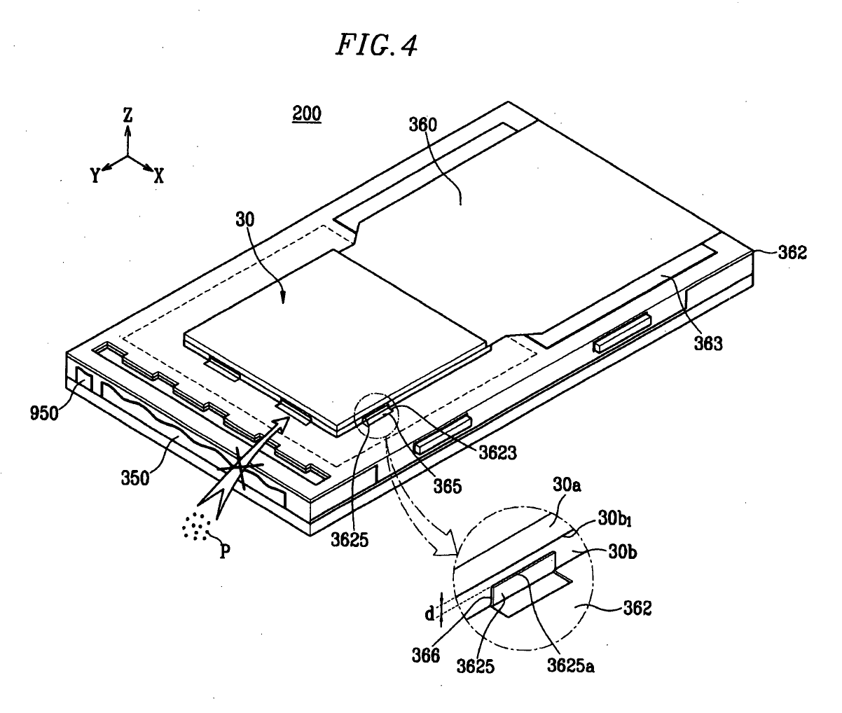

FIG. 4 is a perspective view of a rear portion of an assembled display device 200 according to a second embodiment of the present invention. The FPCB is omitted from FIG. 4 for clarity. The structure of the display device 200 according to the second embodiment of the present invention shown in FIG. 4 is similar to that of the display device 100 according to the first embodiment of the present invention shown in FIG. 1. Therefore, the same elements are indicated by the same reference numerals and detailed explanations thereof will be omitted for convenience.

The circumference of the opening 3621 (shown in FIG. 1) of the fixing member 362 included in the display device 200 is sealed. A sealing member 365 is attached around the opening 3621 of the fixing member 362 in order to seal the display device 200. Therefore, foreign particles P cannot infiltrate the space between the fixing member 362 and the second panel unit 30.

A supporting portion 3625 is formed by cutting and bending a portion of the fixing member 362 near the edge of the opening 3621 of the fixing member 362. The supporting portion 3625 is adjacent to the sides of the second panel unit 30, thereby fixing the second panel unit 30 and preventing lateral movement. With the second panel unit 30 fixed as described above, the structure of the display device 200 can be simplified without using other elements. Therefore, the size and weight of the cellular phone can be significantly decreased when the display device 200 is used in the cellular phone.

An opening 3623 is formed in the fixing member 362 by the cutting and bending of the supporting portion 3625. Since the sealing member 365 is positioned over the opening 3623, the opening 3623 can be easily sealed. Tape comprising a resin film can be used as the sealing member 365.

The enlarged circle of FIG. 4 shows an enlarged view of the supporting portion 3625. Since the fixing member 362 can comprise a metal, the supporting portion 3625 can also comprise a metal. The second panel unit 30 includes a first panel 30a and a second panel 30b, and the ITO film (not shown) is formed therebetween. Therefore, if the supporting portion 3625 and the ITO film contact each other, the display device 200 can be damaged due to a short circuit between the supporting portion 3625 and the ITO film. The first panel 30a may comprise a color filter panel and the second panel 30b may comprise a TFT panel.

In order to prevent a short circuit, a non-conductive member 366 can be attached between the supporting portion 3625 and the second panel unit 30. The non-conductive member 366 prevents the supporting portion 3625 from electrically contacting the ITO film. Therefore, the display device 200 will not be damaged.

If the non-conductive member 366 is not attached, it is also possible to prevent a short circuit by controlling the height of the supporting portion 3625. In particular, if the height of the supporting portion 3625 is less than the thickness of the second panel 30b, a short circuit can be prevented since the supporting portion 3625 does not reach the ITO film.

More specifically, it is preferable that the upper edge 3625a of the supporting portion 3625 is positioned lower than a face 30b₁ of the second panel 30b. Here, the face 30b₁ of the second panel 30b refers to a surface of the second panel 30b facing the first panel 30a. In this case, since the height of the upper edge 3625a of the supporting portion 3625 is low, the supporting portion 3625 does not contact the ITO film, which is located between the face 30b₁ of the second panel 30b and the first panel 30a. Therefore, a short circuit can be avoided.

It is preferable that the height difference d between the upper edge 3625a of the supporting portion 3625 and the face 30b₁ of the second panel 30b be greater than 0.0 mm and less than or equal to 0.2 mm. If the height difference d is 0.0 mm, the supporting portion 3625 may contact the ITO film due to movement of the supporting portion 3625 and/or the second panel 30. In addition, since the height of the supporting portion 3625 is approximately from 0.3 mm to 0.5 mm and the thickness of the second panel 30b including a polarizer is approximately from 0.6 mm to 0.8 mm, it is preferable that the height difference d is not greater than 0.2 mm considering tolerance during manufacture of the display device 200.

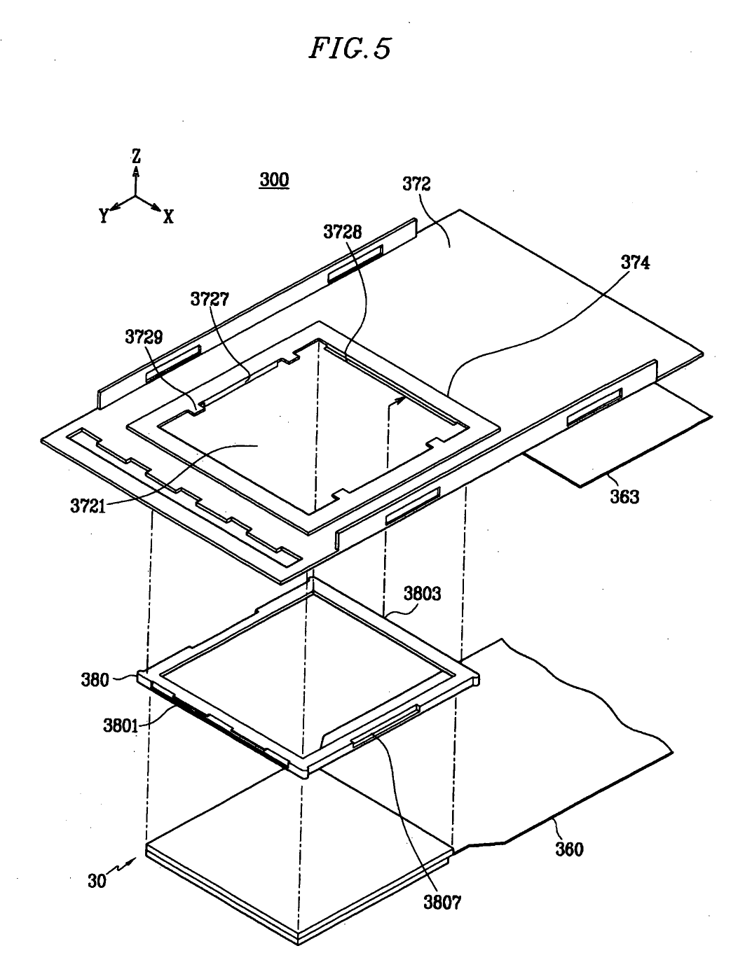

FIG. 5 shows an exploded view of the second panel unit 30 included in a display device 300 according to a third embodiment of the present invention. The structure of the display device 300 according to the third embodiment of the present invention shown in FIG. 5 is similar to that of the display device 100 according to the first embodiment of the present invention of FIG. 1. Therefore, the same elements are indicated by the same reference numerals and detailed explanations thereof will be omitted for convenience.

As shown in FIG. 5, the second panel unit 30 can be fixed using a supporting member 380. The supporting member 380 is installed around an opening 3721 of a fixing member 372 and firmly fixes the second panel unit 30.

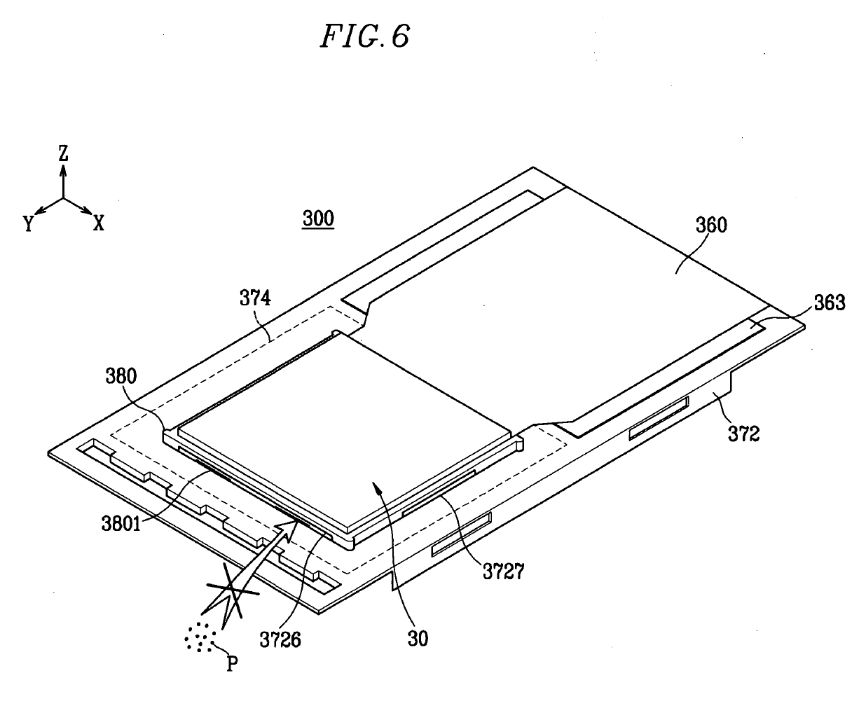

A plurality of protruding portions of various types are formed along the edges of the opening 3721 of the fixing member 372 (protruding portions 3727 and 3728 are shown in FIG. 5 and protruding portions 3726 and 3727 are shown in FIG. 6). A plurality of combining portions of various types are provided in the supporting member 380 (combining portions 3801, 3803, and 3807 are shown in FIG. 5). The combining portions 3801, 3803, and 3807 may comprise, e.g., grooves formed in the side of the supporting member 380. The plurality of protruding portions 3726, 3727, and 3728 are formed in the fixing member 372 in order to firmly fix the supporting member 380 to the fixing member 372. The protruding portion 3726 is shown in FIG. 6. The protruding portions 3726, 3727, and 3728 are received in combining portions 3801, 3807, and 3803 formed in the supporting member 380, respectively. The mating of the protruding portions 3726, 3727, and 3728 with the grooves 3801, 3807, and 3803 firmly combines the supporting member 380 with the fixing member 372.

A sealing member 374 is attached around the opening 3721 of the fixing member 372. Therefore, it is possible to effectively seal the circumference of the opening 3721 of the fixing member 372. The supporting member 380 may comprise a resin and may be formed using a mold-forming method. Therefore, it is possible to manufacture combining portions of various types. Since the combining portions 3801, 3803, and 3807 are combined with the protruding portions 3727, 3728, and 3729, the supporting member 380 can be stably fixed in the fixing member 372.

FIG. 6 is a rear perspective view of a portion of the assembled display device 300 of FIG. 5. As indicated by dotted lines in FIG. 6, the sealing member 374 is attached around the opening 3721 (shown in FIG. 5) of the fixing member 372. The sealing member 374 may comprise tape and can help to prevent foreign particles P from infiltrating the display device 300 through the opening 3721 of the fixing member 372. As a result, it is possible to prevent the display device 300 from being damaged due to the foreign particles P.

Since the second panel unit 30 is mounted on the supporting member 380, it is stably fixed. Therefore, durability of the display device 300 is improved.

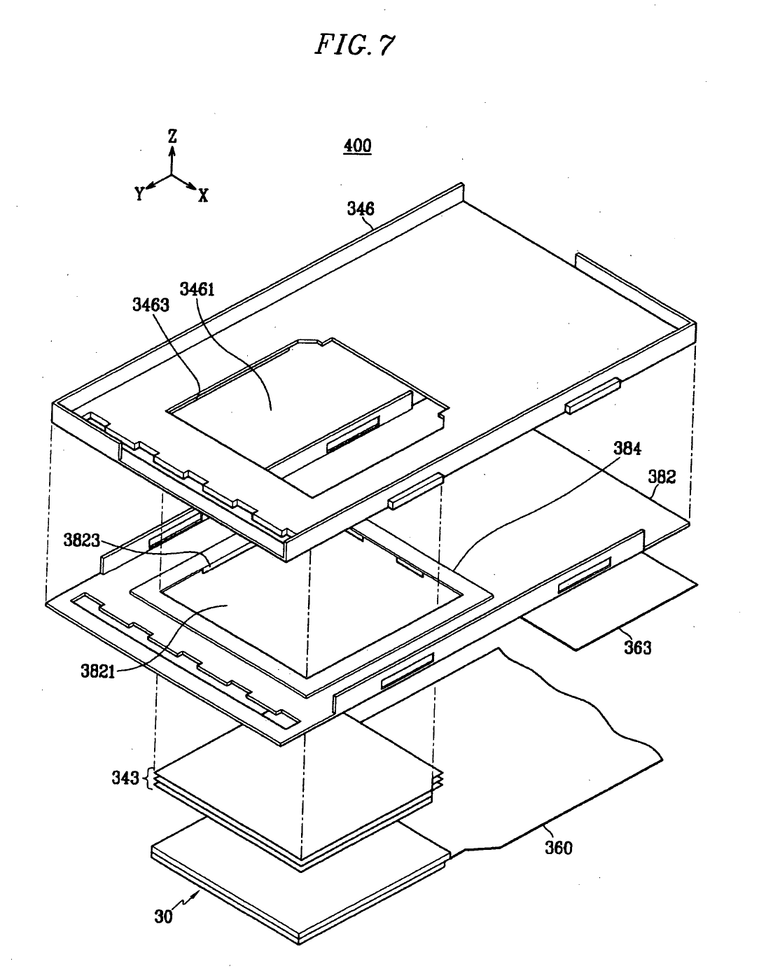

FIG. 7 shows a partial disassembled state of the display device 400 according to a fourth embodiment of the present invention. The structure of the display device 400 according to the fourth embodiment of the present invention shown in FIG. 7 is similar to that of the display device 100 according to the first embodiment of the present invention of FIG. 1. Therefore, the same elements are indicated by the same reference numerals and detailed explanations thereof will be omitted for convenience.

The second panel unit 30 is affixed to the frame member 346 shown in FIG. 7. The frame member 346 has an opening 3461. In addition, the frame member 346 includes a supporting portion 3463 protruding around an edge of the opening 3461. The supporting portion 3463 may comprise multiple members provided on sides of the opening 3461 which protrude toward the second panel unit 30, and pass through an opening 3821 of a fixing member 382. Therefore, the optical sheets 343 and the second panel unit 30 can be fixed between the members of the supporting portion 3463.

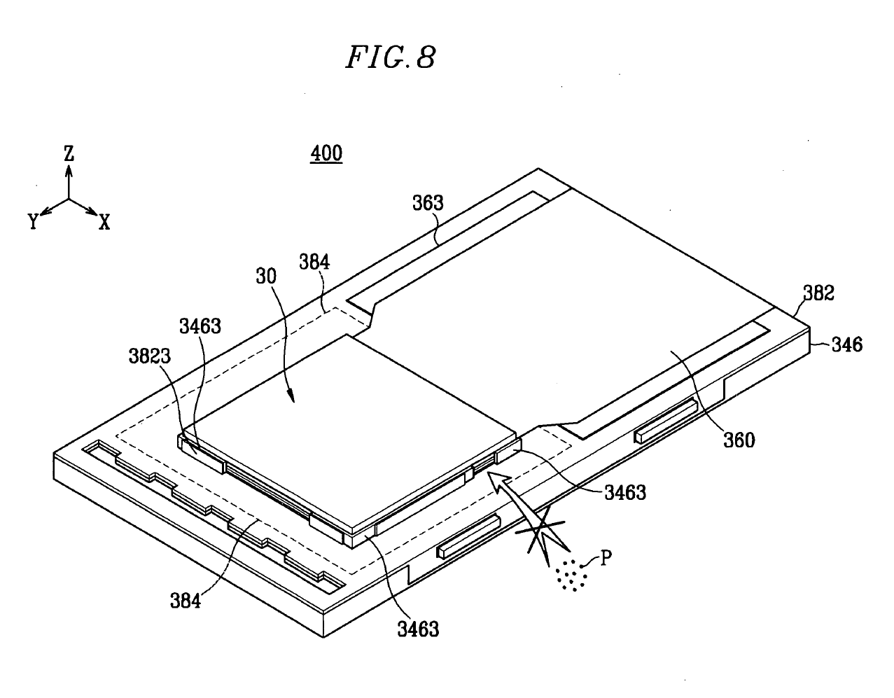

FIG. 8 is a rear perspective view of a portion of the assembled display device 400 of FIG. 7. As indicated by dotted lines in FIG. 8, a sealing member 384 is attached around the opening 3821 (shown in FIG. 7) of the fixing member 382. Therefore, foreign particles P are prevented from infiltrating through the opening 3821 of the fixing member 382.

As shown in FIG. 8, the supporting portion 3463 of the frame member 346 surrounds and fixes the second panel unit 30. Since the supporting portion 3463 is formed on the frame member 346, it is possible to simplify the structure of the display device 400 while stably fixing the second panel unit 30. The fixing member 382 further includes a supporting portion 3823 bent around the opening. The supporting portion 3823 of the fixing member 382 surrounds the supporting portion 3463 of the frame member 346, and thereby the second panel unit 30 is more stably fixed.

The display device according to the first embodiment of the present invention will be explained more below through experimental examples of the present invention. The experimental examples are merely to illustrate the present invention and the present invention is not limited thereto.

### EXPERIMENTAL EXAMPLES

A display device having the same structure as that of the display device shown in FIG. 1 was used for an experiment. A black lamination tape was used as the light absorbing member. LCD panels were used as the panel units and the model number of the display device was LTS180S3-HF. After the display device was manufactured, power was applied to the display device, and an image was displayed on the first panel unit and the second panel unit.

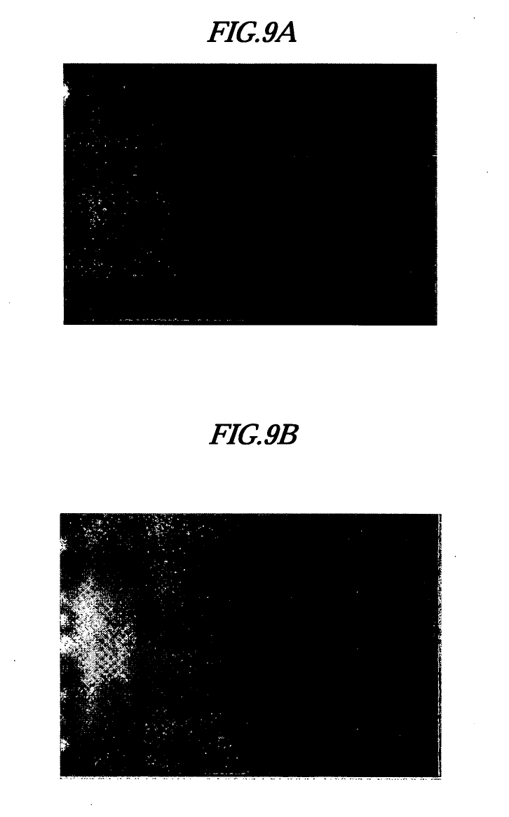

FIG. 9A shows an external plan view of the first panel unit when the display device was operated. The second panel unit is located underneath the first panel unit. The LEDs installed in the left edge of the panel unit of FIG. 9A emitted light. As shown in FIG. 9A, the second panel unit located underneath the first panel unit did not create visible boundaries in the image of the first panel unit. The light which passed through the first panel unit and the light emitted from the light source were absorbed by the light absorbing member, and thereby dark boundaries caused by the second panel unit were not shown. Therefore, it was possible to display a clear image on the first panel unit.

### COMPARATIVE EXAMPLES

For comparison with the above-described experimental example of the present invention, a display device without a light absorbing member was used for the experiment. The model number of the display device was LTS180S3-HF, and the rest of experimental conditions were the same as those of the above experimental example.

FIG. 9B shows an external view of the first panel unit when the display device was operated. The second panel unit is located underneath the first panel unit. The LEDs installed in the left edge of the panel unit of FIG. 9B emitted light. As shown in FIG. 9B, dark boundaries caused by the second panel unit located below could be seen through the first panel unit. Since the light absorbing member was not installed, the light which passed through the first panel unit and the light emitted from the light source were reflected by the side of the fixing member facing the first panel unit. Therefore, the portion of the first panel unit corresponding to the location of the opening in the fixing member for the second panel unit was noticeably darker than the surrounding areas, because the light exited out of the second panel unit rather than being reflected by the back side of the fixing member. Therefore, it was impossible to display a clear image on the first panel unit.

Display devices in accordance with the present invention can prevent foreign particles from infiltrating, and can improve the display performance of the display device. More specifically, it is possible to not only improve the quality of display, but also to prevent the display device from short-circuiting because of foreign particles.

In addition, the sealing member for preventing foreign particles from infiltrating can absorb the light that would otherwise be reflected back out of the panel units. Therefore, it is possible to obtain a clear image on the display device.

Furthermore, in accordance with the present invention, the structure of the display device is not only simplified, but also the panel unit can be stably fixed.

Although the exemplary embodiments of the present invention have been described, it will be understood by those skilled in the art that the present invention may be modified in various forms without departing from the spirit and scope of the appended claims.

What is claimed is:

1. The display device comprising
two or more panel units; and
a fixing member exposing at least one panel unit among the two or more panel units to an exterior of the display device,
wherein a circumference of an opening of the fixing member is sealed.

2. The display device of claim 1, wherein the display device further comprises a light absorbing member positioned between the panel units in order to absorb a portion of light.

3. The display device of claim 2, wherein the light absorbing member is attached to a side of the fixing member facing one of the panel units.

4. The display device of claim 2, wherein the panel units comprise a first panel unit and a second panel unit facing the first panel unit, and a size of a display area of the first panel unit is larger than a size of a display area of the second panel unit.

5. The display device of claim 4, wherein the second panel unit is exposed through the opening of the fixing member, and the light absorbing member is attached on the side of the fixing member facing the first panel unit.

6. The display device of claim 5, wherein the second panel unit and the light absorbing member correspond to the whole surface of the first panel unit.

7. The display device of claim 6, wherein the brightness of a front side of the first panel unit is substantially uniform.

8. The display device of claim 2, wherein the color of the light absorbing member is substantially black.

9. The display device of claim 1, further comprising a sealing member attached around a circumference of the opening of the fixing member to form a seal between the fixing member and at least one of the panel units.

10. The display device of claim 9, wherein the fixing member comprises a supporting portion formed by cutting and bending a portion of the fixing member adjacent to the sides of the panel unit.

11. The display device of claim 10, wherein an opening is formed by the bending of the portion of the fixing member to form the supporting portion, said opening being sealed by tape.

12. The display device of claim 10, wherein each panel unit comprises a first panel and a second panel facing the first panel, and the supporting portion is adjacent to the side of the second panel.

13. The display device of claim 12, further comprising a non-conductive member is attached between the supporting portion and the side of the second panel.

14. The display device of claim 12, wherein the upper edge of the supporting portion is positioned lower than the face of the second panel facing the first panel.

15. The display device of claim 14, wherein a height difference between the upper edge of the supporting portion and the face of the second panel is greater than 0.0 mm and less than or equal to 0.2 mm.

16. The display device of claim 14, wherein the height of the supporting portion is less than that of the second panel.

17. The display device of claim 9, further comprising a supporting member installed around the opening of the fixing member for fixing the panel unit.

18. The display device of claim 17, wherein the fixing member comprises a supporting portion formed in the edges of the opening of the fixing member and the combining portions formed in the sides of the supporting member are mated with the supporting portion of the fixing member.

19. The display device of claim 17, wherein tape is positioned around the opening of the fixing member to form a seal between the fixing member and at least one panel unit.

20. The display device of claim 9, wherein the display device further comprises a frame member for containing at least one panel unit, wherein the frame member comprises an opening and a supporting portion protruding around the opening, the supporting portion penetrating the opening of the fixing member.

21. The display device of claim 20, wherein the supporting portion of the frame member fixes the panel unit by surrounding the panel unit.

22. The display device of claim 20, wherein the fixing member further comprises a supporting portion bent around the opening of the fixing member, wherein the supporting portion of the fixing member surrounds the supporting portion of the frame member.

23. The display device of claim 20, wherein tape is positioned around the opening of the fixing member to form a seal between the fixing member and one of the panel units.

24. The display device of claim 1, wherein:
the display device further comprises a flexible printed circuit film connected to the panel unit; and
the bottom surface of the fixing member is spaced apart from the flexible printed circuit film.

25. The display device of claim 24, wherein the display device further comprises a non-conductive member positioned between the flexible printed circuit film and the fixing member.

26. The display device of claim 25, wherein the non-conductive member comprises a resin film.

27. The display device of claim 25, wherein the non-conductive member is attached to the fixing member.

28. The display device of claim 24, wherein:
the two or more panel units comprise a first panel unit and a second panel unit; and
the flexible printed circuit film connects to the first panel unit and the second panel unit.

29. The display device of claim 1, wherein the display device further comprises a light source supplying light to the panel unit.

30. The display device of claim 29, wherein the light source is a light emitting diode.

31. The display device of claim 1, wherein at least one panel unit among the panel units is a liquid crystal display panel.

32. The display device of claim 1, wherein the display device is used in a cellular phone.
